(19) United States
(12) Patent Application Publication
(10) Pub. No.: US 2026/0317534 A1
(43) Pub. Date: Oct. 15, 2026

(54) Improving the impact resistance of recycled polymers

(71) Applicant: Skytech, LE VAL D'HAZEY (FR)

(72) Inventors: Michaël Georges LEMOINE, PARIS (FR); Thomas, Jacques, Laurent BOGAERT, ASNIERES SUR SEINE (FR); Corentin TOIGO, VERNON (FR)

(21) Appl. No.: 19/099,362

(22) PCT Filed: Jul. 27, 2023
(86) PCT No.: PCT/EP2023/070884

§ 371 Date: Jan. 28, 2025

(30) Foreign Application Priority Data
Jul. 29, 2022 (FR) FR2207875

(51) Int. Cl. C08L 55/02

(52) U.S. Cl. CPC C08L 55/02; C08L 2205/06; C08L 2207/20

(57) ABSTRACT

The present invention relates to a composition comprising:
a recycled polymer, and
an impact modifying additive.

The present invention relates to a composition of recycled polymer. The present invention further relates to a preparation method for such a composition. The present invention further relates to a method for improving the impact strength of a recycled polymer.

Products made of plastic materials are usually formed from virgin plastic materials (also called native materials). However, the expectations of society in terms of preserving the environment and reducing the consumption of resources are growing, and it is therefore necessary to develop new materials obtained from recycled materials, more particularly from recycled polymers.

The disadvantage of using a recycled polymer is that the performance thereof is generally degraded compared to the performance of the corresponding virgin polymer, in particular the impact strength thereof. Moreover, the future use of the recycled polymer is not necessarily identical to the past use thereof, which implies that the properties of the recycled polymer must be modified/suitable for the new use.

There is thus a need for recycled polymer materials exhibiting good performance, in particular mechanical performance, similar to or superior to the performance of the corresponding native polymer materials.

There is, more particularly, a need for recycled polymer materials comprising, if appropriate, at least one additive and exhibiting good impact strength performance.

More particularly, a goal of the present invention is to provide a recycled acrylonitrile-butadiene-styrene polymer composition, if appropriate containing additives, having an IZOD notched impact strength value at 23° C. (ISO 180 standard of 2019) greater than or equal to 8 kJ/m².

Another particular goal of the invention is to provide a recycled polystyrene composition, if appropriate containing additives, having an IZOD notched impact strength value at 23° C. greater than or equal to 5 kJ/m².

There is also a need for a method of determining recycled polymer compositions suitable for use in a predefined use, in particular the manufacture of a specific object. In particular, there is a need for a method of determining the nature and/or the content of an additive to be added to a recycled polymer composition, in order to obtain a final composition comprising a recycled polymer containing additives, apt to be used in a predefined use.

More particularly, there is a need for a method for determining recycled polymer compositions suitable for being used in a predefined use wherein impact strength is an important criterion.

The present invention thus relates to a composition comprising:
a recycled polymer, and
an impact modifier additive.

The inventors discovered that a recycled polymer could exhibit an impact strength similar to or even greater than the impact strength of the corresponding native polymer by adding at least one impact modifier additive.

The inventors have also surprisingly discovered that a recycled polymer containing an additive other than an impact modifier additive has a reduced impact strength compared to the recycled polymer alone, but that it is possible to increase the impact strength by adding an impact modifier additive. It is thereby possible to obtain recycled polymer materials with properties comparable to the properties of the corresponding native polymers, and which can be used in the manufacture of new objects.

### Recycled Polymer

According to ISO 472 of 2013, a recycled plastic material is a plastic material obtained by transformation in a method for producing plastic waste for the purpose of the original function thereof or for other purposes, except for energy recovery.

More precisely, the term “recycled polymer” as defined by the present invention, means a post-consumer polymer, i.e. a polymer that has already been used for the purpose for which same was intended, e.g. for the manufacture of a consumption product, and which would otherwise be disposed of as waste. In contrast, a virgin (or native) polymer is a polymer obtained at the end of the polymerization process allowing the preparation thereof from one or a plurality of monomers. There are also post-industrial polymers, which refer to the plastic waste generated by the manufacturers of the consumption products mentioned hereinabove. Finally, post-production polymers are waste generated by the producers of plastic materials. The thermomechanical properties of post-production polymers are much closer to same of the virgin polymers than to same of post-consumer or post-industrial polymers. Indeed, a post-consumer polymer has undergone shocks and/or temperature variations and/or UV radiation, and the thermomechanical properties thereof are diminished compared to same of a virgin polymer or same of a post-production polymer. A post-industrial polymer also has modified properties compared to a virgin polymer insofar as same has undergone transformation steps.

A recycled polymer according to the invention is a post-consumer polymer or a post-industrial polymer, preferably a post-consumer polymer.

Preferably, the composition according to the invention is characterized by an IZOD impact strength greater than or equal to 6.0 kJ/m², preferably greater than or equal to 8.0 kJ/m², more preferably greater than or equal to 9.8 kJ/m², more preferably between 6.0 and 16 kJ/m², advantageously between 9.8 and 14 kJ/m².

Throughout the description, “IZOD impact strength” means “IZOD notched impact strength at 23° C.” and is determined as per the standard ISO 180 of 2019.

Preferably, the composition according to the invention has a degree of increase in impact strength greater than or equal to 1.1, preferably greater than or equal to 1.2, preferentially greater than or equal to 1.5, more preferentially greater than or equal to 1.8, even more preferentially greater than or equal to 2, advantageously greater than or equal to 2.5, the rate of increase in impact strength being the ratio between the IZOD impact strength value of the composition according to the invention and the IZOD impact strength value of a composition differing from the composition according to the invention solely in that the composition does not contain any impact modifier additive.

Preferably, the degree of increase in the impact strength of the composition according to the invention ranges from 1.1 to 3, preferably from 1.5 to 2.5, preferentially from 1.8 to 2.

Preferably, in the composition according to the invention, the weight concentration of recycled polymer varies from 60% to 98%, preferably from 70% to 95% by weight, preferentially from 80% to 92% by weight, advantageously from 85 to 90% by weight with respect to the total weight of the composition.

Preferably, the recycled polymer is chosen from recycled polystyrenes, recycled acrylonitrile-butadiene-styrene polymers, and any of the mixtures thereof.

Typically, a recycled (or post-consumer) acrylonitrile-butadiene-styrene polymer may have an IZOD impact strength value less than or equal to 12 kJ/m², preferably less than or equal to 9 kJ/m², preferably ranging from 6 to 12 kJ/m², preferentially ranging from 6.5 to 9 kJ/m².

Typically, a recycled (or post-consumer) polystyrene may have an IZOD impact strength value less than or equal to 10 kJ/m², preferably less than or equal to 8 kJ/m², preferably ranging from 3 to 10 kJ/m², preferentially ranging from 4.5 to 7 kJ/m².

According to a first embodiment, the recycled polymer is a recycled acrylonitrile-butadiene-styrene polymer.

The recycled acrylonitrile-butadiene-styrene polymer may be a mixture consisting of recycled acrylonitrile-butadiene-styrene, less than 8% by weight recycled polystyrene, preferably less than 3% by weight, and less than 5% by weight of recycled polypropylene, preferably less than 2% by weight, relative the total weight of the recycled polymer.

According to said embodiment, the composition according to the invention is preferably characterized by an IZOD impact strength greater than or equal to 8.0 kJ/m², preferentially greater than or equal to 10.0 kJ/m², more preferentially greater than or equal to 12.0 kJ/m², more preferentially comprised between 8.0 and 20.0 kJ/m², advantageously comprised between 10.0 and 16.0 kJ/m².

According to a second embodiment, the recycled polymer is a recycled polystyrene.

The recycled polystyrene may be a blend consisting of recycled polystyrene, less than 8% by weight of recycled acrylonitrile-butadiene-styrene polymer, preferably less than 5% by weight, and less than 5% by weight of recycled polypropylene, preferably less than 2% by weight, relative to the total weight of the recycled polymer.

According to said embodiment, the composition according to the invention is preferably characterized by an IZOD impact strength greater than or equal to 5.0 kJ/m², preferably greater than or equal to 6.0 kJ/m², preferentially greater than or equal to 8.0 kJ/m², more preferentially greater than or equal to 10.0 kJ/m², more preferentially comprised between 6.0 and 20.0 kJ/m², advantageously comprised between 8.0 and 18.0 kJ/m².

### Impact Modifier Additive

The composition according to the invention comprises at least one impact modifier additive.

Impact modifier additive means a chemical compound which, when mixed with a polymer, makes the polymer more resistant to impacts. An impact modifier additive is more particularly a polymeric material improving the impact properties of a polymer, e.g. the IZOD notched impact strength at 23° C., as determined as per the standard ISO 180 (2019 version). In French, said term is also known as “modificateurs au choc” or “additifs choc” or else “modificateurs choc”. The term is well known to a person skilled in the art.

Preferably, according to the invention, an impact modifier additive is an additive which enables a polymer comprising 5% by weight of the additive, relative to the total weight of polymer-additive mixture, to exhibit a degree of increase in the impact strength thereof greater than or equal to 1.2, preferentially greater than or equal to 1.5, more preferentially greater than or equal to 2.0.

Thereby, preferably, the impact modifier additive serves to increase by at least 10% the IZOD impact strength of a composition consisting of the recycled polymer and 5% by weight of said impact modifier additive.

Examples of suitable impact modifier additives include, for example graft polymers, core-shell polymers and block copolymers. Such polymers can be obtained from at least one monomer selected from the group consisting of an alkene, an alkadiene, an arene and an acrylate.

Preferably, the impact modifier additive is a copolymer obtained from at least one vinyl monomer.

Copolymer means a polymer derived from the copolymerization of at least two or more chemically different types of monomers, called comonomers.

Vinyl monomer means an organic molecule comprising at least one carbon-carbon double bond. Preferably, the vinyl monomer has the following formula: CH₂═CRR′, where R and R′ are independently selected from the group consisting of a hydrogen atom, an aromatic group, preferably a phenyl, a hydrocarbon group comprising from 1 to 10 carbon atoms, preferably from 2 to 10 carbon atoms, saturated or unsaturated, furthermore comprising, if appropriate, an ester group, a nitrile moiety, a carboxyl moiety, an amine moiety or an amide moiety.

Preferably, the impact modifier additive is a copolymer of ethylene and/or styrene, i.e. at least one of the comonomers of the copolymer is chosen from styrene and ethylene.

Preferably, the impact modifier additive comprises a copolymer obtained by the copolymerization of at least two monomers selected from the group consisting of a C2-C8 alkene, a C4-C8 diene, a styrenic monomer and an acrylic monomer.

Preferentially, the impact modifier additive comprises a copolymer derived from the copolymerization of at least two monomers chosen from the group consisting of ethylene, butene, styrene, butadiene, acrylonitrile, (m)ethyl (meth)acrylate and butyl (meth)acrylate.

In certain embodiments, the impact modifier additive is functionalized or grafted. The functionalized or grafted ethylene copolymer may comprise polar compounds, e.g. comprising an anhydride or epoxy function, preferably cyclic, preferentially maleic anhydride or glycidyl (meth)acrylate.

Preferably, the impact modifier additive is chosen from:
copolymers of ethylene and/or butene and of a polar monomer selected from (m)ethyl acrylate, (m)ethyl methacrylate and butyl (meth)acrylate,
modified acrylonitrile-butadiene-styrene copolymers having a butadiene content greater than or equal to 60% by weight, relative to the total weight of the modified acrylonitrile-butadiene-styrene polymer,
styrene-ethylene/butene-styrene copolymers grafted with maleic anhydride or glycidyl methacrylate,
ethylene-butyl acrylate copolymers, optionally grafted with maleic anhydride,
styrene-butadiene copolymers, preferably styrene-butadiene block copolymers, preferably styrene-butadiene multiblock or diblock copolymers,
styrene-ethylene/butene-styrene copolymers, preferably styrene-ethylene/butene-styrene block copolymers,
and
any of the mixtures thereof.

Advantageously, the impact modifier additive is a copolymer of ethylene and/or butene and a polar monomer chosen from (m)ethyl acrylate, (m)ethyl methacrylate and butyl (meth)acrylate, more advantageously a copolymer of ethylene and a polar monomer chosen from (m)ethyl acrylate and (m)ethyl methacrylate.

(M)ethyl means methyl or ethyl moiety.

(Meth)acrylate means acrylate or methacrylate.

Preferably, the copolymer of ethylene and/or butene and a polar monomer chosen from (m)ethyl acrylate, (m)ethyl methacrylate and butyl (meth)acrylate is a random copolymer. Such a copolymer can be prepared at high pressure from a mixture of ethylene and/or butene and at least one polar monomer chosen from (m)ethyl acrylate, (m)ethyl methacrylate and butyl (meth)acrylate in the presence of a radical polymerization initiator.

The copolymer of ethylene and/or butene and of a polar monomer chosen from (m)ethyl acrylate, (m)ethyl methacrylate and butyl (meth)acrylate preferably comprises from 10% to 40% by weight, preferably from 15% to 35% by weight, else preferably from 26% to 32% by weight of polar monomer relative to the total weight of the copolymer, and from 60% to 90% by weight of ethylene and/or butene, preferably from 65% to 85% by weight, else preferably from 68% to 74% by weight relative to the total weight of the copolymer.

Preferably, the impact modifier additive comprises a copolymer of ethylene and of methyl acrylate.

Examples of copolymers of ethylene and/or of butene and of a polar monomer chosen from (m)ethyl acrylate, (m)ethyl methacrylate and butyl (meth)acrylate include commercial ethylene/methylacrylate copolymers available under the reference Lotryl® 29MA03T from SK Functional Polymer, Elvaloy® copolymers (AC1125, AC12024 S, AC1330) from Dow, or EMAC® SP2260 and Westlake SP248® from EMAC®.

Preferably, the modified acrylonitrile-butadiene-styrene polymer has a butadiene content ranging from 60% to 80%, preferentially ranging from 60% to 65%.

An example of a modified acrylonitrile-butadiene-styrene polymer having a butadiene content greater than or equal to 60% by weight, is the product referenced Kumho® HR 181 from Korea Kumho Petrochemical.

An example of a styrene-ethylene/butene-styrene copolymer functionalized with maleic anhydride, is the product referenced SEBS-g-MA® from Kraton Polymer.

An example of styrene-ethylene/butene-styrene copolymers grafted with maleic anhydride, is the product referenced C1010® from Kraton Polymer.

An example of styrene-ethylene/butene-styrene copolymers grafted with glycidyl methacrylate, is the product referenced 02520 C® from the Graft Polymer company.

An example of ethylene-butyl acrylate copolymers, is the product Lucofin® 1400PN from Lucobit.

An example of ethylene-butyl acrylate copolymers grafted with maleic anhydride, is the product Lucofin® 1492 MGH from Lucobit.

An example of styrene-butadiene copolymer, is the product referenced SBS-C3000® from Kraton Polymer or the product referenced DENKA NSBC® from DENKA.

An example of styrene-ethylene/butene-styrene copolymer, is the product referenced SBS-C2000® from Kraton Polymer.

Preferably, the weight content of impact modifier additive ranges from 0.5% to 20% by weight, preferably from 1% to 18% by weight, preferably from 1% to 16% by weight, preferably from 2% to 13% by weight, preferentially from 3% to 10% by weight, advantageously from 4% to 8% by weight relative to the total weight of the composition.

If the composition comprises a mixture of at least two impact modifier additives, the above weight content defines the sum of the weight content of each impact modifier additive.

According to one embodiment, the impact modifier additive comprises a mixture of:
a copolymer of ethylene and/or butene and a polar monomer selected from (m)ethyl acrylate, (m)ethyl methacrylate and butyl (meth)acrylate, and
a modified acrylonitrile-butadiene-styrene polymer having a butadiene content greater than or equal to 60% by weight relative to the total weight of the modified acrylonitrile-butadiene-styrene polymer.

According to such embodiment, the content of copolymer of ethylene and/or butene and of a polar monomer chosen from (m)ethyl acrylate, (m)ethyl methacrylate and butyl (meth)acrylate preferably ranges from 1% to 15% by weight, preferably from 2% to 12% by weight, preferentially from 3% to 10% by weight, more preferentially from 4% to 8%, more preferentially from 4% to 6% by weight relative to the total weight of the composition.

According to such embodiment, the content of modified acrylonitrile-butadiene-styrene polymer having a butadiene content greater than or equal to 60% by weight relative to the total weight of the modified acrylonitrile-butadiene-styrene polymer preferably varies from 2% to 30% by weight, preferably from 4% to 24% by weight, preferentially from 6% to 20% by weight, more preferentially from 8% to 16%, more preferentially from 8% to 12% by weight relative to the total weight of the composition.

According to such embodiment, the weight ratio between the weight of copolymer of ethylene and/or butene and of a polar monomer chosen from (m)ethyl acrylate, (m)ethyl methacrylate and butyl (meth)acrylate and the weight of modified acrylonitrile-butadiene-styrene polymer having a butadiene content of greater than or equal to 60% by weight relative to the total weight of the modified acrylonitrile-butadiene-styrene polymer is preferably greater than or equal to 1, preferably ranges from 1 to 10, preferentially from 1.5 to 5, advantageously from 2 to 3.

According to such embodiment, the total content by weight of impact modifier additive preferably ranges from 5% to 30%, relative to the total weight of the composition, preferably ranges from 8% to 18% by weight, advantageously ranges from 10% to 15% by weight.

According to another embodiment, the impact modifier additive comprises a mixture of:
a modified acrylonitrile-butadiene-styrene polymer having a butadiene content greater than or equal to 60% by weight relative to the total weight of the modified acrylonitrile-butadiene-styrene polymer, and
a styrene-ethylene/butene-styrene copolymer grafted with maleic anhydride.

According to such embodiment, the content of modified acrylonitrile-butadiene-styrene polymer having a butadiene content greater than or equal to 60% by weight relative to the total weight of the modified acrylonitrile-butadiene-styrene polymer preferably varies from 1% to 15% by weight, preferably from 2% to 10% by weight, preferentially from 3% to 8% by weight relative to the total weight of the composition. According to such embodiment, the content of styrene-ethylene/butene-styrene copolymer grafted with maleic anhydride ranges from 1% to 15% by weight, preferably from 2% to 10% by weight, preferentially from 3% to 8% by weight, relative to the total weight of the composition.

According to another embodiment, the impact modifier additive comprises a mixture of:
a copolymer of ethylene and/or butene and a polar monomer selected from (m)ethyl acrylate, (m)ethyl methacrylate and butyl (meth)acrylate,
a modified acrylonitrile-butadiene-styrene polymer having a butadiene content greater than or equal to 60% by weight relative to the total weight of the modified acrylonitrile-butadiene-styrene polymer, and
a styrene-ethylene/butene-styrene copolymer grafted with maleic anhydride.

According to such embodiment, the content of copolymer of ethylene and/or butene and of a polar monomer chosen from (m)ethyl acrylate, (m)ethyl methacrylate and (meth)butyl acrylate preferably varies from 1% to 15% by weight, preferably from 2% to 10% by weight, preferentially from 3% to 8% by weight relative to the total weight of the composition and/or the content of modified acrylonitrile-butadiene-styrene polymer with a content of butadiene greater than or equal to 60% by weight relative to the total weight of the modified acrylonitrile-butadiene-styrene polymer preferably varying from 1% á 15% by weight, preferably from 2% á 10% by weight, preferentially from 3% to 8% by weight relative to the total weight of the composition and/or the content of styrene-ethylene/butene-styrene copolymer grafted with maleic anhydride preferably varying from 1% to 15% by weight, preferably from 2% to 10% by weight, preferentially from 3% to 8% by weight relative to the total weight of the composition.

According to another embodiment, the impact modifier additive comprises a mixture of:
a copolymer of ethylene and/or butene and a polar monomer selected from (m)ethyl acrylate, (m)ethyl methacrylate and butyl (meth)acrylate,
a modified acrylonitrile-butadiene-styrene polymer having a butadiene content greater than or equal to 60% by weight relative to the total weight of the modified acrylonitrile-butadiene-styrene polymer, and
a styrene-butadiene copolymer.

According to such embodiment, the content of copolymer of ethylene and/or butene and of a polar monomer chosen from (m)ethyl acrylate, (m)ethyl methacrylate and (meth)butyl acrylate preferably varies from 1% to 10% by weight, preferably from 2% to 8% by weight, preferentially from 3% to 7% by weight relative to the total weight of the composition and/or the content of modified acrylonitrile-butadiene-styrene polymer with a content of butadiene greater than or equal to 60% by weight relative to the total weight of the modified acrylonitrile-butadiene-styrene polymer preferably varying from 2% à 20% by weight, preferably from 5% a 15% by weight, preferentially from 8% to 12% by weight relative to the total weight of the composition and/or the content of styrene-butadiene copolymer preferably varying from 1% to 10% by weight, preferably from 2% to 8% by weight, preferentially from 3% to 7% by weight relative to the total weight of the composition.

Such combinations of impact modifier additives have a synergy effect related to the improvement of the IZOD impact strength of the composition.

### Second Additive

Preferably, the composition according to the invention comprises a second additive different from the impact modifier additive.

Preferably, the second additive is different from a copolymer of ethylene and a polar monomer chosen from (m)ethyl acrylate and (m)ethyl methacrylate.

More particularly, the second additive is different from an impact modifier as defined in the present description. For example, the second additive is different from a polymer chosen from the group consisting of a copolymer of ethylene and methyl acrylate, a modified acrylonitrile-butadiene-styrene polymer having a butadiene content greater than or equal to 60% by weight relative to the total weight of the modified acrylonitrile-butadiene-styrene polymer, a styrene-ethylene/butene-styrene copolymer grafted with maleic anhydride, a styrene-butadiene copolymer, a styrene-ethylene/butene-styrene copolymer, an ethylene-butyl acrylate copolymer optionally grafted with maleic anhydride.

Preferably, the second additive is selected from the group consisting of a UV stabilizer, a coloring agent, a curing accelerator, a lubricant, a flame retardant, a thermal polymerization inhibitor, a reinforcing agent, a mineral filler, a diluent, a surfactant, a photosensitizer, a plasticizer, an antioxidant, an additive improving thermal behavior, a fluidizer, and any of the mixtures thereof.

Preferably, the weight content of second additive varies from 1% to 25% by weight, preferably from 2% to 20% by weight, preferentially from 3% to 16% by weight, more preferentially from 4% to 12% by weight, advantageously from 5% to 10% by weight relative to the total weight of the composition.

If the composition comprises a mixture of at least two second additives, the above weight content defines the total weight content of the second additives.

The present invention further relates to a method of preparation of a composition according to the invention, comprising a step of mixing a recycled polymer and an impact modifier additive.

According to one embodiment, the recycled polymer contains additives. A recycled polymer which contains additives comprises a recycled polymer and a second additive as defined in the present description.

According to one embodiment, the preparation method comprises:
a step of mixing a recycled polymer with a second additive, to obtain a recycled polymer containing additives, and
a step of adding an impact modifier additive to the recycled polymer containing additives.

Alternatively, according to said embodiment, the preparation method comprises a step of mixing a recycled polymer, an impact modifier additive and a second additive.

All the definitions, embodiments and preferential features described in the description hereinabove relating to the composition apply to all the variants of the preparation method of the invention.

The present invention further relates to the use of an impact modifier additive in a composition comprising a recycled polymer for increasing the impact strength of said composition.

According to one embodiment, the composition further comprises a second additive different from the impact modifier additive.

All the definitions, embodiments and preferential features described in the description hereinabove relating to the composition apply to all variants of said use.

The present invention further relates to a consumer product comprising a composition according to the invention.

Furthermore, the present invention relates to a method of manufacturing a consumer product, comprising a step chosen from extrusion, injection, molding, rotational molding, thermoforming and calendaring of a composition according to the invention.

Furthermore, the present invention relates to the use of a composition according to the invention, for the manufacturing of a consumer product.

The determination of the composition described in the present description is more particularly facilitated by the implementation of a method for determining the nature and/or the content of an additive to be added to a recycled polymer composition as described hereinbelow.

The present invention thus further relates to a method for determining the nature and/or the content of an additive to be added to a recycled polymer composition in order to obtain a final composition comprising a recycled polymer containing additives, suitable for use in a predefined use, in particular the manufacture of a specific object, comprising:
a) the determination of a first target interval of values required for a first physical quantity of the final composition to be used in the predefined use,
b) the measurement of the value of the first physical quantity for the recycled polymer composition,
c) the addition of an additive to the recycled polymer composition in order to obtain an additive-containing recycled polymer composition to be tested,
d) the measurement of the value of the first physical quantity of the additive-containing recycled polymer composition to be tested, in order to obtain a first measured value to be tested,
e) the testing of a first criterion applied to the first measured value to be tested and to the first target interval, and
f) the selection of the additive if the first criterion is met, or the reiteration of steps c) to f) if the first criterion is not met.

Preferably, the additive is preferably an impact modifier additive or a second additive as defined hereinabove for the composition, in all the variants provided.

Preferably, the recycled polymer is preferably as defined above for the composition, in all the variants provided.

Preferably, the first physical quantity is the IZOD impact strength.

According to one embodiment, the determination method is such that:
step a) furthermore comprises the determination of a second target interval of values required for a second physical quantity of the final composition,
step b) furthermore comprises the measurement of the value of the second physical quantity for the recycled polymer composition,
step d) furthermore comprises the measurement of the value of the second physical quantity of the additive-containing recycled polymer composition to be tested, in order to obtain a second measured value to be tested,
step e) furthermore comprises the testing of a second criterion applied to the second measured value to be tested and to the second target interval, and
step f) comprises the selection of the additive if the first criterion and the second criterion are met, or
the reiteration of steps c) to f) if the first criterion is not met and/or the second criterion is not met.

Preferably, the first physical quantity and, when present, the second physical quantity are independently:
a chemical property such as resistance to corrosion,
an electrical property such as conductivity, conductance, resistance, resistivity or permittivity,
a manufacturing property such as extrudability or hardness,
an optical property like color,
a mechanical property such as IZOD impact strength,
a physical property such as flame retardancy, or
a thermal or thermodynamic property such as Vicat softening point.

Preferably, the additive is a combination of at least two distinct additives.

Preferably, the additive is a combination of an impact modifier additive and at least one second additive as defined hereinabove for the composition, in all the variants provided.

According to a particular embodiment, the first physical quantity is the IZOD impact strength, and:
step a) comprises the determination of a first required target interval of the IZOD impact strength of the final composition,
step b) comprises the measurement of the IZOD impact strength value of the recycled polymer composition,
step c) comprises the addition of an additive to the recycled polymer composition in order to obtain an additive-containing recycled polymer composition to be tested,
step d) comprises the measurement of the IZOD impact strength value of the additive-containing recycled polymer composition to be tested, in order to obtain an IZOD impact strength value to be tested,
step e) comprises the testing of a first criterion applied to the value of the IZOD impact strength to be tested and to the first target interval of the IZOD impact strength, and
step f) comprises the selection of the additive if the first criterion is met, or the reiteration of steps c) to f) if the first criterion is not met.

According to another particular embodiment, the first physical quantity is the IZOD impact strength of the final composition and the second physical quantity is a physical quantity of the final composition different from the IZOD impact strength, and:
step a) comprises the determination of a first required target interval of values of the IZOD impact strength of the final composition and the determination of a second target interval of values required for the second physical quantity of the final composition,
step b) comprises the measurement of the IZOD impact strength value of the recycled polymer composition, and the measurement of the value of the second physical quantity for the recycled polymer composition,
step c) comprises the addition of an additive to the recycled polymer composition in order to obtain an additive-containing recycled polymer composition to be tested,
step d) comprises the measurement of the value of the IZOD impact strength of the additive-containing recycled polymer composition to be tested in order to obtain a value of the IZOD impact strength to be tested, and the measurement of the value of the second physical quantity of the additive-containing recycled polymer composition to be tested in order to obtain a second measurement value to be tested,
step e) comprises the testing of a first criterion applied to the value of the IZOD impact strength to be tested and to the first target interval of the IZOD impact strength, and the testing of a second criterion applied to the second measured value to be tested and to the second target interval, and
step f) is the selection of the additive if the first criterion and the second criterion are met, or
the reiteration of steps c) to f) if the first criterion is not met and/or the second criterion is not met.

Preferably, the second physical quantity is chosen from the Vicat softening point, color, flexural modulus, bending temperature under load, melt index, ductility, flame retardancy, corrosion resistance and the injectability.

Preferably, in embodiments wherein the first physical quantity is the IZOD impact strength, the additive is a combination of at least two distinct additives, at least one of which is an impact modifier additive.

Preferably, in the embodiments wherein the first physical quantity is the IZOD impact strength, the required target interval of the IZOD impact strength is of the type [x; +∞[, with x being a positive real number equal to 8.0 kJ/m², preferably equal to 10.0 kJ/m², more preferably equal to 12.0 kJ/m².

Preferably, in all the embodiments, the first criterion of the determination method according to the invention is whether the first measured value to be tested belongs to the first target interval to within 10%, preferably whether the first measured value to be tested belongs to the first target interval.

Preferably, in all the embodiments, the recycled polymer is chosen from recycled polystyrenes, recycled acrylonitrile-butadiene-styrene polymers, and any of the mixtures thereof.

The method of determining the nature and/or the content of an additive to be added to a recycled polymer composition of the invention serves to obtain a recycled polymer composition meeting the specifications imposed by a specific use.

The present invention thus further relates to a composition intended to be used in a predefined use, in particular the manufacture of a specific object, comprising at least one recycled polymer and at least one additive determined according to the method for determining the nature and/or the content of an additive to be added to a recycled polymer composition of the invention.

The present invention further relates to a method of preparation of a composition intended to be used in a specific use, in particular the manufacture of a specific object, comprising:
the determination of the nature and/or content of an additive according to the method for determining the nature and/or content of an additive to be added to a recycled polymer composition of the invention, and
the mixture of a recycled polymer and of the selected additive.

The present invention further relates to a device for determining at least one additive to be added to a recycled polymer composition in order to obtain a recycled and additive polymer composition suitable for use in a predetermined use, in particular the manufacture of a specific object, comprising:
a device for mixing an additive and a recycled polymer composition in order to obtain a final recycled and additive polymer composition, and
a device for measuring the value of a first physical quantity of the recycled polymer composition and of the final additive-containing recycled polymer composition.

Preferably, the device furthermore comprises an apparatus for measuring a second physical quantity of the recycled polymer composition and the final additive-containing recycled polymer composition.

Preferably, the device for measuring the value of the first physical quantity of the recycled polymer composition and of the final additive-containing recycled polymer composition is an apparatus for measuring the IZOD impact strength.

The present invention further relates to a system for the preparation of an additive recycled polymer composition intended to be used in a predefined use, the system including:
an inlet of recycled polymer, in particular of recycled polymer obtained by sorting waste, and
a unit for inserting an additive into the recycled polymer.

All the definitions, embodiments and preferential features described in the above description concerning the composition or the method apply to all variants of the determination method of the invention, to the composition intended to be used in a predefined use of the invention, to the method of preparation of a composition intended to be used in a specific use of the invention, to the device of the invention and to the system for the preparation of a composition of the invention.

For the entire description, the expression “from . . . to . . . ” describes a range of values the bounds are included in the range.

The invention will now be described by means of the following non-limiting examples.

### EXAMPLES

In all the following examples, the IZOD impact strength was determined as per the standard ISO 180 (2019 version).

The compositions marked with an asterisk are comparative.

The contents are indicated as a percentage by weight relative to the total weight of the composition (% by weight), unless otherwise stated.

### Example 1: Improvement of the Impact Strength of Recycled ABS or PS

To prepare the compositions of the present example, the recycled ground material was compounded by adding the impact modifier additive through metering hoppers.

In the compositions of the present example, the following materials and additives were used:
ABS “batch EGR0064”
PS “batch EGR0072”
Impact modifier additive 1: ethylene-methyl acrylate copolymer (Lotryl 29MA03T®)
Impact modifier additive 2: a modified acrylonitrile-butadiene-styrene polymer having a butadiene content greater than or equal to 60% by weight relative to the total weight of the modified acrylonitrile-butadiene-styrene polymer (HR-181®)
Impact modifier additive 3: styrene-butadiene block copolymer (C3000®)
Impact modifier additive 4: styrene-butadiene-styrene triblock copolymer (SBS GI®
Impact modifier additive 5: styrene-butadiene block copolymer (SBS KTR 201®)
Impact modifier additive 6: styrene-ethylene/butene-styrene copolymer grafted with maleic anhydride (C1010®)

TABLE 1

| | | | Content | |
|---|---|---|---|---|
| | | | of impact | |
| | | Nature of | modifier | IZOD |
| | Nature of | the impact | additive | notched |
| | the recycled | modifier | (% by | 23° C. |
| Ref | polymer | additive | weight) | (kJ/m²) |
| C1-1* | ABS | — | — | 7.93 ± 0.28 |
| C1-2 | ABS | 1 | 5% | 14.7 ± 0.3 |
| C1-3 | ABS | 1 | 7% | 16.80 ± 0.58 |
| C1-4 | ABS | 1 | 10% | 18 ± 0.5 |
| C1-7 | ABS | 1 | 15% | 19.8 ± 0.4 |
| C1-8 | ABS | 2 | 2% | 10.60 ± 0.27 |
| C1-9 | ABS | 2 | 4% | 14.20 ± 0.44 |
| C1-10 | ABS | 2 | 7% | 14.70 ± 0.59 |
| C1-11 | ABS | 2 | 10% | 15.3 ± 0.39 |
| C1-12 | ABS | 2 | 15% | 19.1 ± 0.9 |
| C1-21* | PS | — | — | 3.32 ± 0.11 |
| C1-22 | PS | 3 | 5% | 7.0 ± 0.06 |
| C1-23 | PS | 4 | 5% | 8.45 ± 0.24 |
| | | (SBS GI) | | |
| C1-24 | PS | 5 (SBS | 5% | 8.2 ± 0.13 |
| | | KTR 201) | | |
| C1-25 | PS | 6 | 2.5% | 3.6 ± 0.1 |

*comparative example

### Example 2: Improvement of the Impact Strength of Additive-Containing Recycled ABS or PS

The compositions were prepared as follows:

The recycled ground material was first mechanically mixed with the second additive. During compounding, the second impact modifier additive was added using metering hoppers.

In the compositions of the present example, the following materials and additives were used:
Impact modifier additive 1: ethylene-methyl acrylate copolymer (Lotryl 29MA03T®)
Impact modifier additive 3: styrene-butadiene block copolymer (C3000®)
Impact modifier additive 5: styrene-butadiene block copolymer (SBS KTR 201®)

TABLE 2

| | | Nature of | | |
|---|---|---|---|---|
| | | the impact | | |
| | | modifier | Second | IZOD |
| | Nature of | additive | additive ^{a} | notched |
| | the recycled | (% by | (% by | 23° C. |
| Ref | polymer | weight) | weight) | (kJ/m²) |
| C2-1* | PS “batch | — | — | 5.9 ± 0.19 |
| | PGR0072” | | | |
| C2-2* | PS “batch | — | 2% | 4.99 ± 0.14 |
| | PGR0072” | | | |
| C2-3 | PS “batch | 1 | 2% | 6.96 ± 0.38 |
| | PGR0072” | (1%) | | |
| C2-4 | PS “batch | 1 | 2% | 6.94 ± 0.90 |
| | PGR0072” | (2%) | | |
| C2-5 | PS “batch | 1 | 2% | 8.31 ± 0.60 |
| | PGR0072” | (3%) | | |
| C2-6 | PS “batch | 1 | 2% | 9.72 ± 1.19 |
| | PGR0072” | (4%) | | |
| C2-7 | PS “batch | 1 | 2% | 9.99 ± 0.39 |
| | PGR0072” | (5%) | | |
| C2-8 | PS “batch | 1 | 2% | 10.20 ± 0.56 |
| | PGR0072” | (6%) | | |
| C2-9 | PS “batch | 1 | 2% | 12.20 ± 0.39 |
| | PGR0072” | (10%) | | |

^{a} The second additive was selected from the group consisting of a UV stabilizer, a coloring agent, a curing accelerator, a lubricant, a flame retardant, a thermal polymerization inhibitor, a reinforcing agent, a mineral filler, a diluent, a surfactant, a photosensitizer, a plasticizer, an antioxidant, an additive improving thermal behavior, a fluidizer, and any of the mixtures thereof.
*comparative example

TABLE 3

| | | Impact | | |
|---|---|---|---|---|
| | | modifier | Second | IZOD |
| | Nature of | additive | additive ^{a} | notched |
| | the recycled | (% by | (% by | 23° C. |
| Ref | polymer | weight) | weight) | (kJ/m²) |
| C2-10* | ABS “batch | — | — | 10.90 ± 0.37 |
| | EGR0064” | | | |
| C2-11* | ABS “batch | — | 2% | 10.20 ± 0.31 |
| | EGR0064” | | | |
| C2-12 | ABS “batch | 1 | 2% | 11.70 ± 0.38 |
| | EGR0064” | (1%) | | |
| C2-13 | ABS “batch | 1 | — | 12.80 ± 0.32 |
| | EGR0064” | (1%) | | |
| C2-14 | ABS “batch | 1 | 2% | 12.70 ± 0.58 |
| | EGR0064” | (2%) | | |
| C2-15 | ABS “batch | 1 | — | 13.40 ± 0.47 |
| | EGR0064” | (2%) | | |
| C2-16 | ABS “batch | 1 | 2% | 14.0 ± 0.68 |
| | EGR0064” | (4%) | | |
| C2-17 | ABS “batch | 1 | 2% | 14.80 ± 0.78 |
| | EGR0064” | (6%) | | |
| C2-18 | ABS “batch | 1 | 2% | 16.50 ± 1.14 |
| | EGR0064” | (10%) | | |

^{a} The second additive was selected from the group consisting of a UV stabilizer, a coloring agent, a curing accelerator, a lubricant, a flame retardant, a thermal polymerization inhibitor, a reinforcing agent, a mineral filler, a diluent, a surfactant, a photosensitizer, a plasticizer, an antioxidant, and a fire-retardant.

TABLE 4

| | | Impact | | |
|---|---|---|---|---|
| | | modifier | Second | IZOD |
| | Nature of | additive | additive ^{a} | notched |
| | the recycled | (% by | (% by | 23° C. |
| Ref | polymer | weight) | weight) | (kJ/m²) |
| C2-20* | PS “batch | — | — | 3.3 |
| | PGR0072” | | | |
| C2-21* | PS “batch | — | 5% | 2.3 |
| | PGR0072” | | | |
| C2-22 | PS “batch | 3 | — | 7.0 ± 0.1 |
| | PGR0072” | (5%) | | |
| C2-23 | PS “batch | 3 | 5% | 6.1 ± 0.2 |
| | PGR0072” | (5%) | | |
| C2-24 | PS “batch | 5 | — | 8.2 ± 0.1 |
| | PGR0072” | (5%) | | |
| C2-25 | PS “batch | 5 | 5% | 7.8 ± 0.1 |
| | PGR0072” | (5%) | | |

^{a} The second additive was selected from the group consisting of a UV stabilizer, a coloring agent, a curing accelerator, a lubricant, a flame retardant, a thermal polymerization inhibitor, a reinforcing agent, a mineral filler, a diluent, a surfactant, a photosensitizer, a plasticizer, an antioxidant, and an fire-retardant.
*comparative example

The results show that 1) the addition of the second additive further reduces the impact strength of recycled polymers, and 2) that the addition of an impact modifier additive significantly improves the impact strength of the additive-containing recycled polymers.

### Example 3: Effect of Synergy Between at Least Two Impact Modifier Additives According to the Invention

To prepare the compositions of the present example, the recycled ground material was compounded by adding the additive(s) chosen from among the impact modifier additives by means of metering hoppers.

In the compositions of the present example, the following materials and additives were used:
ABS “batch EGR0064”
Impact modifier additive 1: ethylene-methyl acrylate copolymer (Lotryl 29MA03T®)
Impact modifier additive 2: a modified acrylonitrile-butadiene-styrene polymer having a butadiene content greater than or equal to 60% by weight relative to the total weight of the modified acrylonitrile-butadiene-styrene polymer (HR-181®)

TABLE 5

| | | Impact | Impact | |
|---|---|---|---|---|
| | | modifier | modifier | IZOD |
| | Nature of | additive 1 | additive 2 | notched |
| | the recycled | (% by | (% by | 23° C. |
| Ref | polymer | weight) | weight) | (kJ/m²) |
| C3-1* | ABS | — | — | 7.93 ± 0.28 |
| C3-2 | ABS | 15 | — | 19.8 ± 0.5 |
| C3-4 | ABS | — | 15 | 19.1 ± 0.9 |
| C3-5 | ABS | 10 | 5 | 21.4 ± 0.7 |

*comparative example

At an equivalent amount of impact modifier additive, the compositions comprising a mixture of two impact modifiers exhibited better impact strength than compositions comprising a single impact modifier, demonstrating an effect of synergy between the two impact modifier additives.

1. A composition comprising:
a recycled polymer, and
an impact modifier additive.

2. The composition according to claim 1, wherein the impact modifier additive increases by at least 10%, the IZOD impact strength of a composition consisting of the recycled polymer and 5% by weight of said impact modifier additive.

3. The composition according to claim 1, wherein the impact modifier additive is selected from the group consisting of:
copolymers of ethylene and/or butene and a polar monomer selected from (m)ethyl acrylate, (m)ethyl methacrylate and butyl (meth)acrylate,
modified acrylonitrile-butadiene-styrene copolymers having a butadiene content greater than or equal to 60% by weight, relative to the total weight of the modified acrylonitrile-butadiene-styrene polymer,
styrene-ethylene/butene-styrene copolymers grafted with maleic anhydride or glycidyl methacrylate,
ethylene-butyl acrylate copolymers, optionally grafted with maleic anhydride,
styrene-butadiene copolymers, styrene-butadiene block copolymers, or styrene-butadiene multiblock or diblock copolymers,
styrene-ethylene/butene-styrene copolymers, or styrene-ethylene/butene-styrene block copolymers, and
any of the mixtures thereof.

4. The composition according to claim 1, wherein the impact modifier additive is a copolymer of ethylene and/or butene and a polar monomer selected from (m)ethyl acrylate, (m)ethyl methacrylate and butyl (meth)acrylate.

5. The composition according to claim 1, wherein the impact modifier additive comprises a mixture of:
a copolymer of ethylene and/or butene and a polar monomer selected from (m)ethyl acrylate, (m)ethyl methacrylate and butyl (meth)acrylate, and
a modified acrylonitrile-butadiene-styrene polymer having a butadiene content greater than or equal to 60% by weight relative to the total weight of the modified acrylonitrile-butadiene-styrene polymer.

6. The composition according to claim 1, wherein the weight content of impact modifier additive ranges from 0.5% to 20% by weight, relative to the total weight of the composition.

7. The composition according to claim 1, furthermore comprising a second additive different from the impact modifier additive.

8. The composition according to claim 7, wherein the weight content of the second additive varies from 1% to 25% by weight, relative to the total weight of the composition.

9. The composition according to claim 1, wherein the weight concentration of the recycled polymer varies from 60% to 98%, with respect to the total weight of the composition.

10. The composition according to claim 1, wherein the recycled polymer is selected from the group consisting of recycled polystyrenes, recycled acrylonitrile-butadiene-styrene polymers, and any of the mixtures thereof.

11. The composition according to claim 1, having a degree of increase in impact strength greater than or equal to 1.1, the degree of increase in impact strength being the ratio between the IZOD impact strength value of the composition according to any one of the preceding claims and the IZOD impact strength value of a composition differing from the composition of claim 1 solely in that the composition does not contain any impact modifier additive.

12. A method of preparation of a composition according to claim 1, comprising a step of mixing a recycled polymer and an impact modifier additive.

13. A method for increasing the impact strength of a composition comprising a recycled polymer, comprising a step of adding an impact modifier additive in said composition.

14. A consumer product comprising a composition according to claim 1.

15. A method of manufacturing a consumer product, comprising a step chosen from extrusion, injection, molding, rotational molding, thermoforming and calendaring of a composition according to claim 1.

16. (canceled)
